(19) United States
(12) Patent Application Publication
(10) Pub. No.: US 2024/0338928 A1
(43) Pub. Date: Oct. 10, 2024

(54) VIDEO PROCESSING APPARATUS, VIDEO PROCESSING METHOD, AND PROGRAM

(71) Applicant: Nippon Telegraph and Telephone Corporation, Tokyo (JP)

(72) Inventors: Hidenobu Nagata, Musashino-shi, Tokyo (JP); Hirokazu KAKINUMA, Musashino-shi, Tokyo (JP); Shota YAMADA, Musashino-shi, Tokyo (JP); Kota HIDAKA, Musashino-shi, Tokyo (JP)

(21) Appl. No.: 18/294,444

(22) PCT Filed: Aug. 27, 2021
(86) PCT No.: PCT/JP2021/031486

§ 371 Date: Feb. 1, 2024

(51) Int. Cl. G06V 10/764; G06T 5/50; G06T 7/194

(52) U.S. Cl. CPC G06V 10/764; G06T 5/50; G06T 7/194; G06T 2207/20221

(57) ABSTRACT

A video processing device 1 includes: a foreground extraction unit 12 configured to classify each pixel in an input image as foreground, background or unclassifiable; an error rate evaluation unit 13 configured to obtain an error rate for unclassifiable pixels based on previous classification results to calculate an evaluated value representing difficulty of classification; a processing unit 14 configured to arrange an effect to be superimposed on a subject image classified as foreground in accordance with the evaluated value; and the output unit 15 configured to output an output image obtained by superimposing the effect on the subject image.

### TECHNICAL FIELD

The present invention relates to a video processing device, a video processing method and a program.

### BACKGROUND ART

Subject extraction processing is processing of extracting only a region corresponding to a specific subject from a captured video and outputting of a video showing only the subject. In the extraction of a subject region, the subject region in a frame image is estimated using a background difference, machine learning or deep learning, a foreground label is assigned to each pixel in the subject region, and only the pixels to which the foreground label is assigned are filtered out to extract a subject image including only the subject.

### CITATION LIST

### Non Patent Literature

Non Patent Literature 1: Aseem Agarwala, et al., “Keyframe-Based Tracking for Rotoscoping and Animation”, ACM Transactions on Graphics (Proceedings of SIGGRAPH 2004), 2004.
Non Patent Literature 2: Unity5, Internet <URL: https://docs.unity3d.com/>

### SUMMARY OF INVENTION

### Technical Problem

The extraction accuracy of the subject is less likely to be 100%, and a portion where the subject does not exist may be erroneously extracted or extracted with a hole due to an error that a foreground label is not assigned to a subject region. Accordingly, a subjective quality of the subject image may be deteriorated.

The present invention is intended to address the problem stated above, and an object thereof is to suppress deterioration in subjective quality in subject extraction.

### Solution to Problem

A video processing device according to one aspect of the present invention includes: a foreground extraction unit configured to classify each pixel in an input image as foreground, background or unclassifiable; an error rate evaluation unit configured to obtain an error rate for unclassifiable pixels based on previous classification results to calculate an evaluated value representing difficulty of classification; and an output unit configured to output a subject image extracting pixels classified as foreground from the input image and the evaluated value.

A video processing method according to one aspect of the present invention, which is executed by a computer, includes: classifying each pixel in an input image as foreground, background or unclassifiable; obtaining an error rate for unclassifiable pixels based on previous classification results to calculate an evaluated value representing difficulty of classification; and outputting a subject image extracting pixels classified as foreground from the input image and the evaluated value.

### Advantageous Effects of Invention

According to the present invention, deterioration in subjective quality can be suppressed in subject extraction.

### BRIEF DESCRIPTION OF DRAWINGS

FIG. 1 is a diagram illustrating one example of a configuration of a video processing device according to the present embodiment.

FIG. 2 illustrates one example of a look-up table for determining whether a pixel belongs to a foreground or a background.

FIG. 3 is a diagram illustrating one example of a pixel with a higher evaluated value.

FIG. 4 is a diagram illustrating one example in which an effect is superimposed on a pixel having a higher evaluated value.

FIG. 5 is a flowchart illustrating one example of a flow of processing for assigning a foreground label or a background label to each pixel.

FIG. 6 is a diagram illustrating one example of a hardware configuration of the video processing device.

### DESCRIPTION OF EMBODIMENTS

An embodiment of the present invention will be described with hereinbelow reference to the drawings.

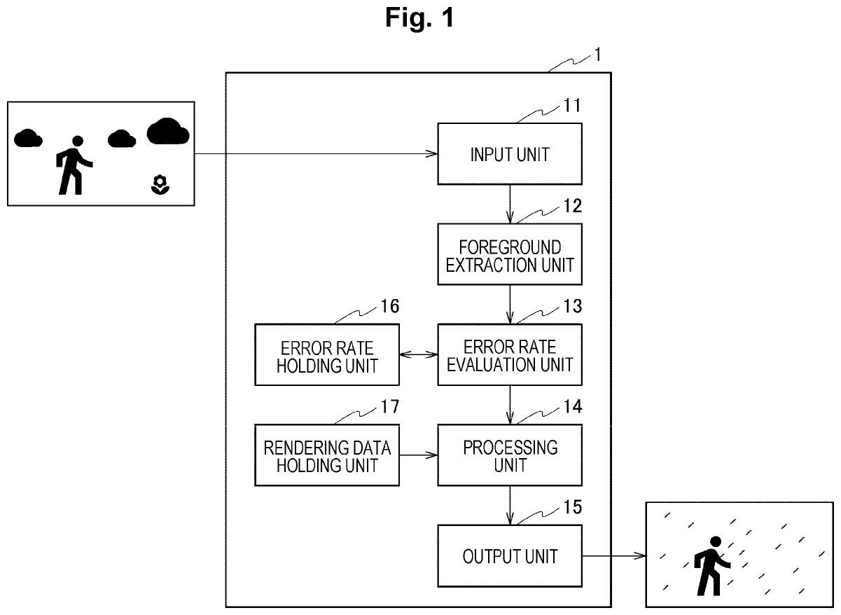

One example configuration of the video processing device according to the present embodiment will be described with reference to FIG. 1. The video processing device 1 of the present embodiment is a device that inputs a video, extracts a subject from each frame of the video to generate a subject image, and applies a rendering process to the subject image to generate an output image. For example, a video obtained by capturing a stage is input to the video processing device 1. The video processing device 1 extracts performers from the input video and generates and outputs a video to which a rendering process is applied. The output video is transmitted to a remote place and combined with another background. Each unit of the video processing device 1 will be described below.

The video processing device 1 illustrated in FIG. 1 includes an input unit 11, a foreground extraction unit 12, an error rate evaluation unit 13, a processing unit 14, an output unit 15, an error rate holding unit 16, and a rendering data holding unit 17.

The input unit 11 inputs each frame of the video and transmits the input frame to the foreground extraction unit 12. The frame is hereinafter referred to as an input image.

The foreground extraction unit 12 determines whether each pixel of the input image is a foreground or a background. For example, the foreground extraction unit 12 obtains the probability that each pixel belongs to the foreground or the background using a lookup table (LUT) created in advance, and assigns a foreground label or a background label in accordance with the obtained probability.

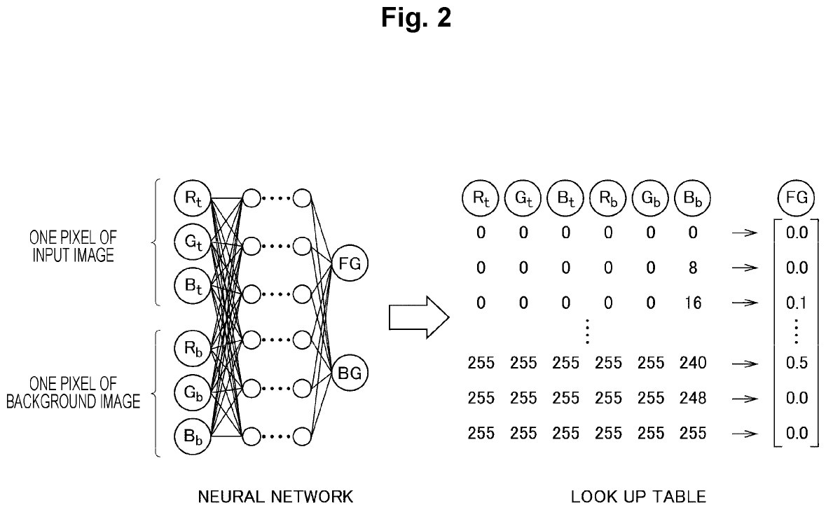

One example of the LUT will be described with reference to FIG. 2. The LUT shown in FIG. 2 holds an output combination of a neural network that identifies the foreground and the background. For example, in the learning process of a neural network, a background image that does not contain a subject, a sample image that contains a subject, and a mask image that is the correct answer are used. A pixel value of a pixel of interest in the sample image corresponding to the foreground of the mask image and a pixel value of a corresponding pixel in the same position as the pixel of interest in the background image are combined to form an input feature vector. The neural network learns this combination as a foreground region. Similarly, for a pixel corresponding to the background of the mask image, the neural network learns a combination of the pixel of interest in the sample image and the corresponding pixel in the background image as a background region. Accordingly, the neural network can be obtained, which is capable of identifying whether the combination of the pixel of interest in the input image and the corresponding pixel in the background image belongs to the foreground or the background. Since the neural network operation needs a large load of calculation, the neural network operation processing is implemented in the LUT to increase the speed and enable extraction processing in real time. When the LUT is created, an input feature vector is reduced to a small number of gradations by quantization processing in order to reduce a LUT size. The output combinations of all the neural networks of the quantized input feature vectors are held as LUTs.

When the LUT is used, the foreground extraction unit 12 uses the pixel of interest in the input image and the corresponding pixel in the background image as input feature vectors, quantizes the input feature vectors, and refers to the LUT to obtain a probability that the pixel of interest belongs to the foreground. The foreground extraction unit 12 inputs the background image in advance. The foreground extraction unit 12 assigns a foreground label to the pixel of interest when the obtained probability of belonging to the foreground is high, and assigns a background label to the pixel of interest when the probability is low.

Depending on a pixel value, there is a pixel that cannot be classified. It is a pixel in which an error relatively occurs. In a case where the probability obtained by referring to the LUT is a value within a predetermined range, for example, in a case where the probability of belonging to the foreground and the probability of belonging to the background are approximately the same (50%), the foreground extraction unit 12 transmits the pixel of interest as an unclassifiable pixel to the error rate evaluation unit 13.

The foreground extraction unit 12 may derive an alpha mask having a value in a range from 0 to 1 for a region including the unclassifiable pixel. The pixel to which the foreground label is assigned has the alpha value of 1, and the pixel to which the background label is assigned has the alpha value of 0. In the subsequent processing of generating a subject image, the subject image is extracted by applying the alpha mask to the input image.

A process of extracting the foreground region by the foreground extraction unit 12 is not limited to the process using the LUT, and other methods such as a background difference may be adopted.

The error rate evaluation unit 13 obtains an error rate of the unclassifiable pixel, and outputs an evaluated value indicating difficulty of classification in accordance with the error rate. For example, the error rate evaluation unit 13 obtains, as the error rate, the number of times of determination as unclassifiable pixels with respect to the total number of frames so far. The evaluated value may be a value obtained by classifying the error rate into several stages, or may be the error rate itself. The higher the evaluated value, the more difficult it is to classify that the pixel belongs to the foreground or the background. The error rate holding unit 16 records information necessary for calculation of the error rate such as the number of times of classifying a specific pixel as foreground, background, or unclassifiable for all the frames and each pixel.

The foreground extraction unit 12 and the error rate evaluation unit 13 assign the foreground label, the background label, or the evaluated value to each pixel of the input image.

The processing unit 14 superimposes an image for an effect on the video in accordance with rendering. Any image can be used. The effect is superimposed on the pixel to which the error rate is assigned by the error rate evaluation unit 13 or superimposed on an area including a plurality of pixels including the pixel stated above. As an effect image at this time, a simple geometric pattern including particles or lines, or alternatively, fog, rain, confetti, withered leaves, petals, snow and light spots can be employed. The processing unit 14 controls a position and time such that the effect is superimposed on a pixel having a higher evaluated value. Although the error rate varies for each frame, the effect to be superimposed may be associated for each frame, or may be maintained for a certain number of frames set in advance. Furthermore, coordinates can be changed by applying any amount of fluctuation to a state in which the effect is superimposed. Based on the effect image described above, the rendering data holding unit 17 holds, as rendering data, data in which the effect image is arranged in a pixel position or a region including pixels at which a specified error rate is achieved. The effect is not limited to the image described above, and an abstract image such as a glossy mark, a trademark or a pattern image can be used.

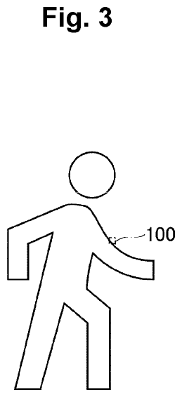

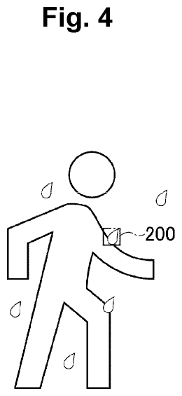

One example in which the processing unit 14 superimposes the effect will be described with reference to FIGS. 3 and 4. A pixel 100 shown in FIG. 3 is a pixel having a higher evaluated value. As illustrated in FIG. 4, the processing unit 14 arranges an effect 200 at a position of the pixel having a higher evaluated value (pixel 100 in FIG. 3). Furthermore, the processing unit 14 arranges the effect in a distributed manner regardless of the evaluated value so that the effect looks natural. The processing unit 14 may select a pixel on which the effect is to be superimposed in descending order of the evaluated value.

In the case of an effect having a large hidden area, such as a fog effect, the processing unit 14 may arrange the fog effect such that a plurality of pixels having higher evaluated values are hidden.

In the case of an effect with slow movement such as leaf-fall, the processing unit 14 may control the movement of the effect such that a pixel having a higher evaluated value is hidden, and may change a direction in which leaves move or slightly vary the falling speed of leaves.

The output unit 15 extracts pixels to which the foreground label is assigned from the input image to generate the subject image, and superimposes the effect image generated by the processing unit 14 on the subject image to generate the output image. The processing unit 14 may generate the subject image by extracting the subject from the input image, and generate the output image by arranging the effect on the generated subject image.

The video processing device 1 may not include the processing unit 14, and the output unit 15 may output the subject image obtained by extracting the pixels to which the foreground label is assigned from the input image and the evaluated value of each pixel. In this case, a processing device for adding effects may be provided downstream of the video processing device 1, and the processing device may arrange the effect to be superimposed on the subject image in accordance with the evaluated value.

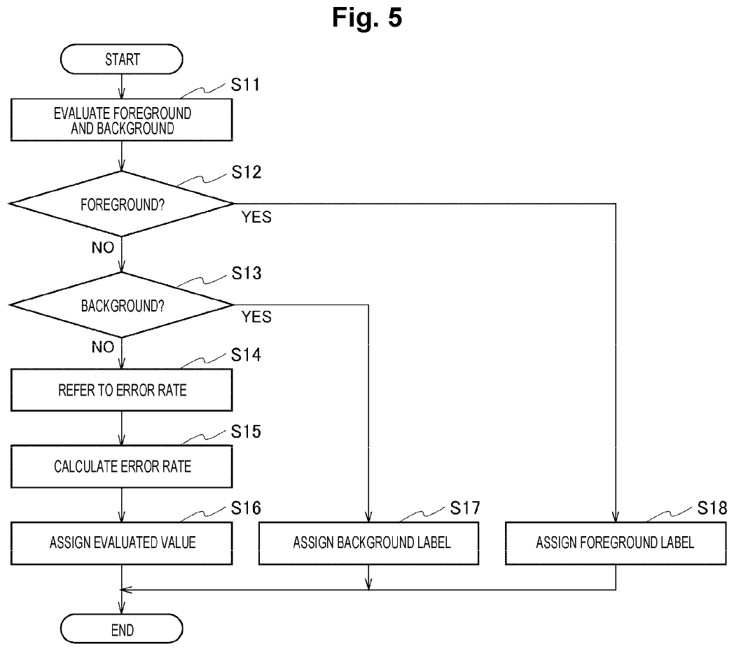

Hereinbelow, processing of assigning the foreground label or the background label to each pixel in the input image will be described with reference to the flowchart shown in FIG. 5. The processing illustrated in the flowchart of FIG. 5 is executed for each pixel of the input image.

In step S11, the video processing device 1 refers to the LUT and evaluates whether the pixel of interest belongs to the foreground or the background. In particular, the video processing device 1 refers to the LUT and acquires the probability of belonging to the foreground corresponding to the combination of the pixel of interest and the corresponding pixel in the background image.

In step S12, the video processing device 1 determines whether the pixel of interest belongs to the foreground on the basis of the probability that the pixel of interest belongs to the foreground, which has been obtained in step S11.

In a case where the pixel of interest belongs to the foreground, the video processing device 1 assigns the foreground label to the pixel of interest in step S18.

In step S13, the video processing device 1 determines whether the pixel of interest belongs to the background on the basis of the probability that the pixel of interest belongs to the foreground, which has been obtained in step S11.

In a case where the pixel of interest belongs to the background, the video processing device 1 assigns the background label to the pixel of interest in step S17.

In a case where the pixel of interest is not classified into the foreground or the background, the video processing device 1 refers to the error rate of the pixel of interest in step S14, and calculates and updates the error rate in step S15.

In step S16, the video processing device 1 assigns the evaluated value corresponding to the error rate to the pixel of interest. Furthermore, the video processing device 1 may obtain the alpha value of the unclassifiable pixel, or may assign the foreground label or the background label to the unclassifiable pixel.

When the processing above has been executed for each pixel of the input image, the video processing device 1 extracts the pixels to which the foreground label is assigned from the input image and generates the subject image. In the case of applying the rendering process to the subject image, the video processing device 1 performs the rendering process such that a pixel having a higher evaluated value is processed to the extent possible.

As stated above, the video processing device 1 of the present embodiment includes: the foreground extraction unit 12 configured to classify each pixel in an input image as foreground, background or unclassifiable; the error rate evaluation unit 13 configured to obtain an error rate for unclassifiable pixels based on previous classification results to calculate an evaluated value representing difficulty of classification; a processing unit 14 configured to arrange an effect to be superimposed on a subject image classified as foreground in accordance with the evaluated value; and the output unit 15 configured to output an output image obtained by superimposing the effect on the subject image. Accordingly, even in the case where the subject extraction result by the foreground extraction unit 12 is wrong, the rendering process is superimposed on the pixel having a higher evaluated value and in which the subject extraction is likely to be wrong, so that it is possible to suppress deterioration in subjective quality.

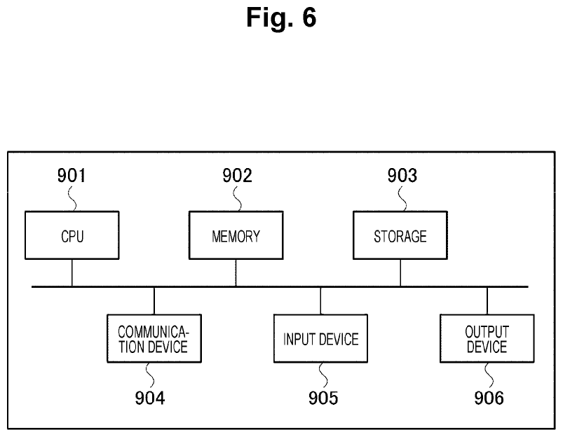

As the video processing device 1 described above, for example, a general-purpose computer system including a central processing unit (CPU) 901, a memory 902, a storage 903, a communication device 904, an input device 905, and an output device 906 as illustrated in FIG. 6 can be used. In this computer system, the CPU 901 executes a predetermined program loaded on the memory 902, thereby implementing the video processing device 1. This program can be recorded on a computer-readable recording medium such as a magnetic disk, an optical disc, or a semiconductor memory, or can be distributed via a network.

### REFERENCE SIGNS LIST

1 Video processing device
11 Input unit
12 Foreground extraction unit
13 Error rate evaluation unit
14 Processing unit
15 Output unit
16 Error rate holding unit
17 Rendering data holding unit

1. A video processing device comprising:
a foreground extraction unit, including one or more processors, configured to classify each pixel in an input image as foreground, background or unclassifiable;
an error rate evaluation unit, including one or more processors, configured to obtain an error rate for unclassifiable pixels based on previous classification results to calculate an evaluated value representing difficulty of classification; and
an output unit configured, including one or more processors, to output a subject image extracting pixels classified as foreground from the input image and the evaluated value.

2. The video processing device according to claim 1, further comprising:
a processing unit, including one or more processors, configured to arrange an effect to be superimposed on the subject image in accordance with the evaluated value,
wherein the output unit is configured to output an output image in which the effect is superimposed on the subject image.

3. A video processing method executed by a computer, the video processing method comprising:
classifying each pixel in an input image as foreground, background or unclassifiable;
obtaining an error rate for unclassifiable pixels based on previous classification results to calculate an evaluated value representing difficulty of classification; and
outputting a subject image extracting pixels classified as foreground from the input image and the evaluated value.

4. The video processing method according to claim 3, executed by the computer, the video processing method further comprising:
arranging an effect to be superimposed on the subject image in accordance with the evaluated value; and
outputting an output image in which the effect is superimposed on the subject image.

5. A non-transitory computer-readable storage medium storing a program for causing a computer to perform operations comprising:
classifying each pixel in an input image as foreground, background or unclassifiable;
obtaining an error rate for unclassifiable pixels based on previous classification results to calculate an evaluated value representing difficulty of classification; and
outputting a subject image extracting pixels classified as foreground from the input image and the evaluated value.

6. The non-transitory computer-readable storage medium according to claim 5, wherein the operations further comprise:
arranging an effect to be superimposed on the subject image in accordance with the evaluated value; and
outputting an output image in which the effect is superimposed on the subject image.
